(19) United States
(12) Patent Application Publication
(10) Pub. No.: US 2026/0164014 A1
(43) Pub. Date: Jun. 11, 2026

(54) EXTENDED MASK AND BUFFER TECHNIQUES FOR VIDEO COMPRESSION AND DECOMPRESSION

(71) Applicant: InterDigital VC Holdings, Inc., Wilmington, DE (US)

(72) Inventors: Renan Utida Barbosa Ferreira, Montreal (CA); Saurabh Puri, Saint-Lazare (CA); Charles Bonnineau, Montreal (CA); Ismail Marzuki, Montreal (CA)

(21) Appl. No.: 18/970,630

(22) Filed: Dec. 5, 2024

(51) Int. Cl. H04N 19/105; H04N 19/159; H04N 19/176; H04N 19/196

(52) U.S. Cl. CPC H04N 19/105; H04N 19/159; H04N 19/176; H04N 19/196

(57) ABSTRACT

A computer-implemented method for encoding a video frame includes selecting a block from a plurality of blocks within the video frame, identifying a reference block within a reference boundary region of the video frame, the reference boundary region being defined by a fixed mask, and the reference boundary region being less than all of the video frame, determining prediction parameters based on a relationship between the selected block and the identified reference block, and encoding, with an encoder, the prediction parameters and an indicator of the fixed mask into a bitstream.

### BACKGROUND

The present application is related to encoding and decoding video using intra frame reconstruction techniques. More specifically, the present application is related to providing extended masks and buffers for intra frame reconstruction of video data including both static and dynamic content.

### BRIEF SUMMARY

Briefly stated, in one embodiment, a computer-implemented method for encoding a video frame includes selecting a block from a plurality of blocks within the video frame, identifying a reference block within a reference boundary region of the video frame, the reference boundary region being defined by a fixed mask, and the reference boundary region being less than all of the video frame, determining prediction parameters based on a relationship between the selected block and the identified reference block, and encoding, with an encoder, the prediction parameters and an indicator of the fixed mask into a bitstream.

Briefly stated, in another embodiment, a computer-implemented method for decoding a video frame includes decoding, with a decoder, prediction parameters and an indicator of a fixed mask from a bitstream, selecting the fixed mask based on the indicator, locating a reference block within a reference boundary region of the video frame, the reference boundary region being defined by the fixed mask, and the reference boundary region being less than all of the video frame, and reconstructing a first block of the video frame based on the reference block and the prediction parameters.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1 is a block diagram illustrating an example system according to one or more embodiments of the present disclosure;

FIG. 2 is a block diagram illustrating an example video encoder according to one or more embodiments of the present disclosure;

FIG. 3 is a block diagram illustrating an example video decoder according to one or more embodiments of the present disclosure;

FIG. 4 is a block diagram illustrating an example of a default mask and an example of a selected coding tree unit according to one or more embodiments of the present disclosure;

FIG. 5 is a block diagram illustrating a first example of an extended mask and an associated intra block copy (IBC) reference buffer according to one or more embodiments of the present disclosure;

FIG. 6 is a block diagram illustrating a second example of an extended mask and an associated IBC reference buffer according to one or more embodiments of the present disclosure;

FIG. 7 is a block diagram illustrating a third example of an extended mask and an associated IBC reference buffer according to one or more embodiments of the present disclosure;

FIG. 8 is a flowchart illustrating an example process for encoding a video frame according to one or more embodiments of the present disclosure; and

FIG. 9 is a flowchart illustrating an example process for decoding a video according to one or more embodiments of the present disclosure.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

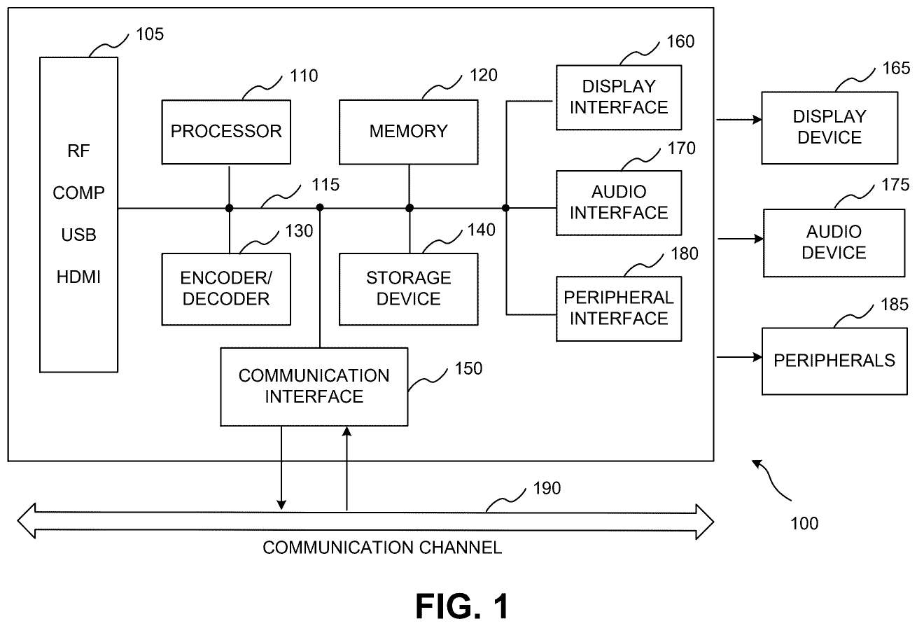

Referring to the drawings, there is shown in FIG. 1 a block diagram illustrating an example system 100 in which embodiments of the present disclosure can be implemented. The system 100 may be an electronic device including, for example, a personal computer, laptop computer, mobile phone, tablet computer, multimedia set-top box, digital television receiver, personal video recording system, connected home appliance, vehicle control and/or entertainment system, and server. One or more elements of the system 100, singly or in combination, may be implemented as an integrated circuit (IC), multiple ICs, and/or discrete components. For example, in one embodiment, the processing, encoding and/or decoding elements of system 100 are distributed across multiple ICs and/or discrete components. In some embodiments, the system 100 is communicatively coupled to and/or in communication with other systems or devices, via, for example, a communications bus or dedicated input/output ports.

One or more of the elements of system 100 may be provided within an integrated housing, with such elements being interconnected and able to transmit data therebetween using any suitable connection arrangement 115 generally known in the art, including, for example, an internal bus (e.g., I2C bus), wiring, and printed circuit boards.

The system 100 includes at least one processor 110 configured to execute instructions for implementing the embodiments described herein, including signal/data coding and processing. The processor 110 may be a general-purpose processor or microprocessor, digital signal processor (DSP), one or more microprocessors in association with a DSP core, a controller, a microcontroller, application specific integrated circuits (ASICs), field programmable gate arrays (FPGAs), a state machine, and the like. The processor 110 may include at least one central processing unit (CPU), embedded memory, input and output interfaces, and other circuitries.

The system 100 includes at least one memory 120, for example, a volatile memory device and/or a non-volatile memory device. The system 100 includes a storage device 140, that may be or include non-volatile memory and/or dynamic volatile memory, including EEPROM, ROM, PROM, RAM, DRAM, SRAM, DDR, flash, magnetic disk drives, solid state drives (SSD) and/or optical disk drives. The storage device 140 may be or include, for example, an internal storage device, an attached storage device, and/or a network accessible storage device. Although shown separately, the memory 120 and the storage device 140 may be collocated, integrated together, or otherwise combined.

The system 100 includes an encoder/decoder module 130 configured to process video data and to provide encoded video data or decoded video data. The encoder/decoder module 130 may include one or more processors and/or memory (not shown). Although FIG. 1 depicts the encoder/decoder module 130 as a separate element of system 100, it will be understood that the processor 110 and the encoder/decoder module 130 may be collocated and/or integrated together as a combination of hardware and/or software, e.g., in an electronic package or chip. The encoder/decoder module 130 may be or include one or more modules that may be included in one or more separate devices that perform encoding and/or decoding functions.

Instructions for execution by the processor 110 and/or the encoder/decoder module 130 may be stored in the storage device 140 and subsequently loaded into memory 120 for execution by the processor 110. In some embodiments, one or more of processor 110, memory 120, storage device 140, and encoder/decoder module 130 may store one or more items when performing the processes disclosed herein. Such items may include input video, decoded video or portions thereof, bitstreams, matrices, variables, operational logic, and intermediate and/or final results from processing of equations, formulas, or operations.

In some embodiments, the memory of the processor 110 and/or the encoder/decoder module 130 is used to store instructions and/or provide working memory for video encoding and decoding functions. In some embodiments, memory external to the processor 110 and/or the encoder/decoder module 130 (e.g., the memory 120 and/or the storage device 140) is used for one or more of these functions and/or, for example, to store the operating system of a television.

The system 100 may obtain or receive information via one or more input devices, interfaces, and/or ports as indicated in input block 105. Examples of the input devices include a radio frequency (RF) device for transmitting and/or receiving RF signals over various media, for example, RF signals received over the air from a broadcaster; component video (COMP) inputs; a Universal Serial Bus (USB) input; and/or a High-Definition Multimedia Interface (HDMI) input. Other examples include composite video input (not shown). In some embodiments, the input devices are associated with respective input processing elements, e.g., those generally known in the art. For example, the RF device may be associated with elements suitable for selecting a desired frequency (e.g., selecting or band-limiting a signal) or performing error correction on the signal. The USB and/or HDMI inputs may include respective interface processors and transceivers (or transmitters and receivers) for coupling the system 100 to other devices via USB and/or HDMI ports or connections. Various forms of input processing may be implemented, for example, by and/or within a separate input processing device or the processor 110.

The system 100 includes a communication interface 150 that enables wired and/or wireless communication with other devices, e.g., via a communication channel 190. The communication interface 150 may include one or more transceivers, modems, network cards and the like. The communication channel 190 may be or include wired and/or wireless mediums.

In some embodiments, data may be streamed to the system 100 via wired and/or wireless networks. Examples of such wireless networks include cellular, Bluetooth or Wi-Fi (e.g., IEEE 802.11) networks. The wired and/or wireless networks may include one or more base stations (e.g., cellular base stations, access points, etc.), and/or user equipment (e.g. cellular user equipment, stations, etc.), and/or other network elements that communicate with the system 100 via the communication interface 150 and communication channel 190, whereby the system 100 may obtain data streamed from streaming applications (e.g., OTT services) via various networks, including the Internet. In some embodiments, data is streamed to the system 100 via the input block 105 (e.g., using a set-top box that delivers data via the HDMI connection or the RF connection). In some embodiments, data is received by the system 100 in a non-streaming manner.

The system 100 may provide one or more output signals to one or more output devices. The output devices may include a display device 165 (e.g., touchscreen display, monitor, etc.), an audio device 175 (e.g., speakers), and other peripheral devices 185, including, for example, a stand-alone DVR, a disk player, a stereo system, a lighting system, and other devices that provide a function based on the output of the system 100. The display device 165 can be for a television, tablet, laptop, mobile phone, head-mounted display, or other device. In some embodiments, control signals are communicated between the system 100 and the display device 165, the audio device 175, and/or the peripheral devices 185, enabling device-to-device control with or without user intervention. The output devices may couple to and/or communicate with the system 100 via dedicated connections via respective display, audio, and peripheral interfaces 160, 170, 180. Alternatively, the output devices may couple to and/or communicate with the system 100 via the communication channel 190 and the communication interface 150.

The display device 165 and the audio device 175 may be collocated, integrated, or otherwise combined with the other components of system 100 in a single unit (e.g., a television). Alternatively, the display device 165 and the audio device 175 may be separate from one or more of the other components of the system 100. In embodiments in which the display device 165 and the audio device 175 are external components, the output signals may be provided via dedicated outputs and/or connections, including, for example, HDMI ports, USB ports, or COMP outputs.

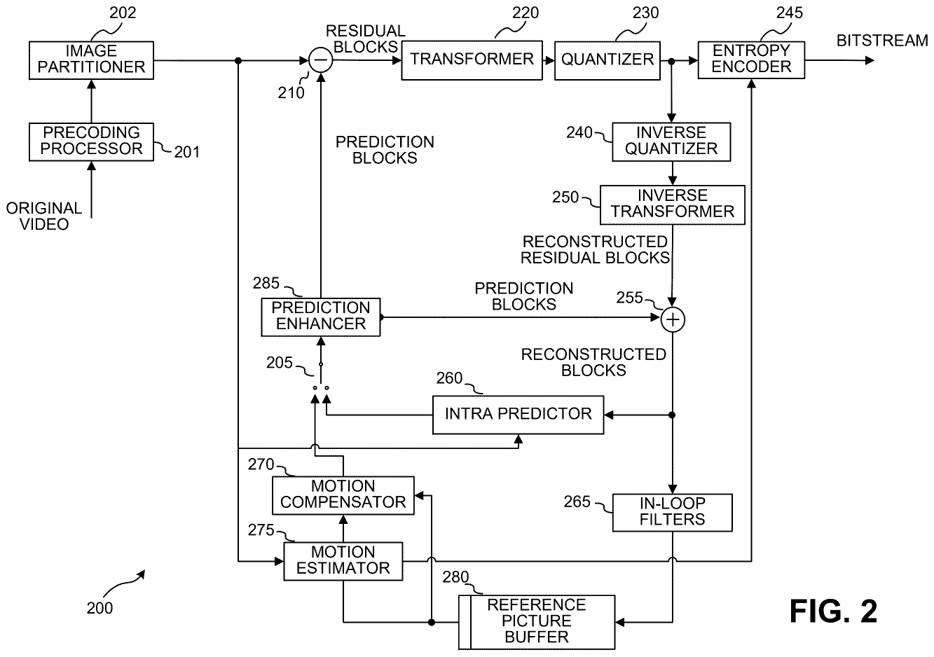

FIG. 2 is a block diagram illustrating an example video encoder 200 that may be employed by the system 100 (e.g., via the encoder/decoder module 130) described with respect to FIG. 1. The video encoder 200 may be an encoder that employs video compression technologies, standards, specification, or protocols, including Advanced Video Coding (AVC, H.264/MPEG-4), High Efficiency Video Coding (HEVC, H.265), Versatile Video Coding (VVC, H.266), Essential Video Coding (EVC, MPEG-5), AOMedia Video 1 (AV1), VP9, or the Enhanced Compression Model (ECM), and variations or improvements thereof. Those skilled in the art will understand that the various embodiments described herein are not limited to a specific standard and can be applied to other standards and recommendations, as well as extensions thereof.

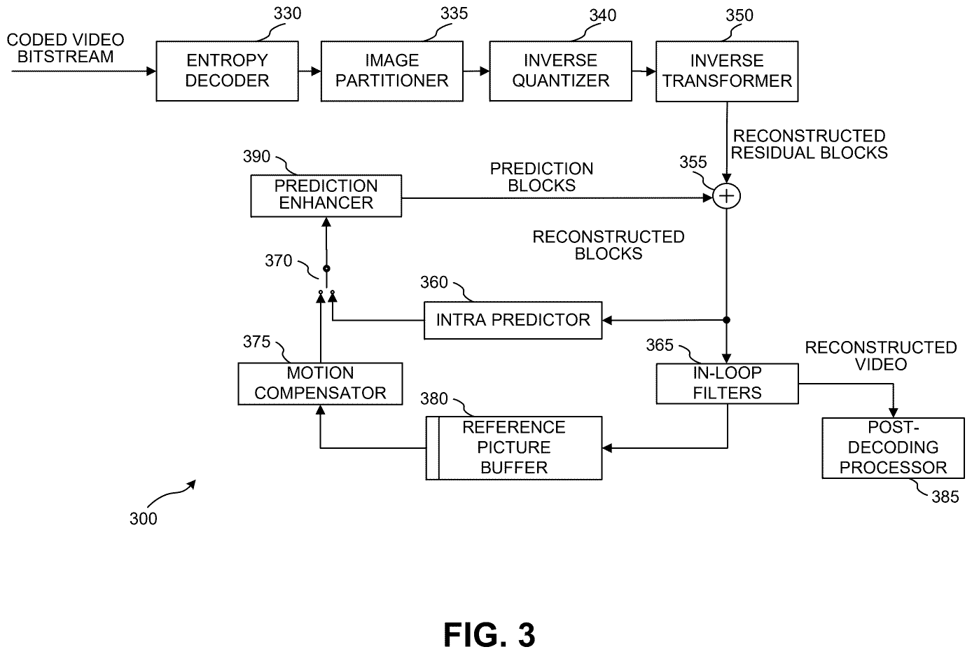

Some embodiments disclosed herein are described with reference to a coding unit (CU) or block of a video frame (or a video image or picture) to which coding tools may be applied by the video encoder 200 and/or by the video decoder 300 (described below with reference to FIG. 3). Generally, embodiments described herein may be applied to a video region formed by a video partition of any shape or size. The video region may be a video slice, a coding tree unit (CTU), or a CU (to which inter prediction or intra prediction can be applied), or a partition thereof, each of which can include samples of a luma component, Y, and chroma components, U and V (also denoted herein by C).

Referring generally to FIG. 2 and the video encoder 200, video data (e.g., one or more video frames) is encoded generally as described below. Prior to encoding, video data may be pre-processed by a precoding processor 201. The pre-processing may include, for example, applying a color model transform to the input color components of the input video data (e.g., conversion from RGB 4:4:4 to YUV 4:2:0 or from RGB 4:4:4 to YCbCr 4:2:0) or mapping the color components of the input video data to obtain a signal distribution that is more resilient to compression (for instance, applying a histogram equalizer and/or a denoising filter to one or more of the video data's color components). The pre-processing may include associating metadata (for example, a supplemental enhancement information (SEI) message) with the video data that can be attached to a coded video bitstream. After pre-processing, if any, an image (frame) to be encoded is partitioned into CUs (blocks) by an image partitioner 202.

In general, a CU includes a luma block and associated chroma blocks. As such, functions of the video encoder 200 described herein as applied to a CU refer generally to the luma block and the respective chroma blocks. The CUs may be encoded using an intra prediction mode performed by an intra predictor 260. In intra prediction mode, the content of a CU in a frame is predicted based on content from one or more other CUs of the same frame (or region), using reconstructed blocks of other CUs output from an adder 255. The CUs may also or alternatively be encoded using an inter prediction mode, in which motion estimation and motion compensation are performed by a motion estimator 275 and a motion compensator 270, respectively. In inter prediction mode, the content of a CU in a frame is predicted based on content from one or more reconstructed areas of reference frames, available from a reference picture buffer 280.

The video encoder 200 selects or otherwise determines at 205 which prediction mode (intra prediction mode and/or inter prediction mode) to use for encoding a CU. The selected prediction mode may be enhanced (e.g., filtered) by a prediction enhancer 285. Based on the selected mode, a prediction for the CU is generated. A residual block is determined based on the prediction (i.e., prediction block, predicted CU) and the input CU. In some embodiments, such determination is made by a subtractor 210. In various implementations, prediction residuals, such as prediction residual blocks, are calculated by subtracting the prediction block from the original image block (e.g., the input CU), for example, at the subtractor 210.

The residual block or a partition thereof (e.g., a transform block) is transformed into transform coefficients by a transformer 220. The transform coefficients are quantized by a quantizer 230. An entropy encoder 245 performs entropy encoding of the quantized transform coefficients and coding parameters (e.g., syntax elements including motion vectors and other control data) to form a bitstream of coded video data. In various implementations, the video encoder 200 bypasses the transformer 220 and/or the quantizer 230, encoding the residual block directly at the entropy encoder 245.

In addition to coding the original video blocks as described herein, the video encoder 200 reconstructs (e.g., by decoding) the coded blocks to provide references for future predictions. Thus, quantized transform coefficients (from the quantizer 230) are de-quantized by an inverse quantizer 240, and inverse transformed by an inverse transformer 250, to reconstruct (decode) the residual blocks. The reconstructed residual blocks and prediction blocks are combined (e.g., by the adder 255) to form reconstructed blocks. Thus, the video encoder 200 performs decoding operations through which the encoded images (frames) are reconstructed.

In-loop filters 265 may be applied to the reconstructed image (formed by the reconstructed blocks). The filtered reconstructed image(s) are stored in the reference picture buffer 280 and used by the motion estimator 275 and motion compensator 270, as explained above. The in-loop filters 265 can be applied to the reconstructed samples of an image to reduce distortions introduced by the encoding process. For example, a deblocking filter (DBF), bilateral filter (BIF), sample adaptive offset (SAO), and/or adaptive loop filter (ALF) can be applied to reduce encoding artifacts.

FIG. 3 is a block diagram illustrating an example of video decoder 300 that may be employed by the system 100 (e.g., via the encoder/decoder module 130) described with respect to FIG. 1. Generally, operational features of the video decoder 300 are reciprocal to operational features of the video encoder 200. As previously described, the video encoder 200 may also perform video decoding as part of the video data encoding process. In the video decoder 300, a coded video bitstream (e.g., generated by the video encoder 200 or another video encoding device or process) is entropy-decoded by an entropy decoder 330 to obtain transform coefficients, prediction modes, motion vectors, picture partition information, and other coding parameters. Based on the coding parameters, an image partitioner 335 divides the picture accordingly. For example, the image partitioner 335 may divide the picture according to the decoded picture partitioning information. The quantized transform coefficients are de-quantized by an inverse quantizer 340 and inverse transformed by an inverse transformer 350 to decode (reconstruct) respective residual blocks. Depending on the selected prediction mode, a predicted block can be obtained at 370 from an intra predictor 360 (i.e., intra prediction) or from a motion compensator 375 (i.e., inter prediction) and may be enhanced (e.g., filtered) by a prediction enhancer 390, generating a prediction block. The reconstructed residual blocks are combined with prediction blocks (e.g. by an adder 355), resulting in reconstructed blocks.

In-loop filters 365 (e.g., DBF, BIF, SAO, and/or ALF) can be applied to the reconstructed image (formed by the reconstructed blocks), to output reconstructed (decoded) video. The filtered reconstructed image is also stored in a reference picture buffer 380 for reference by the motion compensator 375.

A post-decoding processor 385 can process the reconstructed video data. For example, post-decoding processing can include an inverse color model transform (e.g., conversion from YUV 4:2:0 to RGB 4:4:4 or from YCbCr 4:2:0 to RGB 4:4:4) or an inverse mapping to reverse the mapping process performed by the pre-encoding processor described with respect to FIG. 2. The post-decoding processor 385 can use metadata derived by the pre-encoding processor 201 and/or signaled in the video bitstream.

In various implementations, the video encoder 200 and/or the video decoder 300 may implement intra block copy (IBC) techniques to encode and/or decode video data. When performing IBC, a video frame may be divided into coding tree units (CTUs), which may represent the largest processing units within the frame. Each CTU may be further subdivided into smaller blocks, which may, in some examples, represent luma and/or chroma components into the video signal. IBC may operate as a distinct prediction mode, separate from the previously described intra prediction and inter prediction modes. IBC may allow for the substantial reuse of similar or identical blocks or CTUs within the same video frame by predicting a selected block based on reconstructed blocks from within the same video frame. Thus, IBC may leverage spatial redundancies within the same video frame, reducing the need to repeatedly encode or decode redundant information.

For example, the encoder 200 may select a block or CTU to be encoded. The encoder 200 may search selected regions of the same frame (stored in an IBC reference buffer) to identify a reference block or CTU that is identical to or closely matches the selected block or CTU. The encoder 200 then computes a displacement between the selected block or CTU and the reference block or CTU, along with any residual differences. The encoder 200 may encode these values into the bitstream—instead of the entire selected block or CTU—reducing the amount of data required.

At the decoder 300, the process may be reversed. When decoding a selected block or CTU, the decoder 300 may retrieve the corresponding reference block or CTU from an IBC reference buffer, for example, based on the displacement information decoded from the bitstream. The decoder 300 may reconstruct the selected block or CTU by applying any residual differences to the retrieved reference block or CTU, recreating the original content with high fidelity. Thus, the IBC process ensure the efficient reuse of spatially redundant information, reducing computational overhead while improving compression ratios.

IBC may be technically challenging to implement when encoding/decoding video data that includes dynamic content—such as regions including of high motion or complex textures—due to the lack of spatial redundancies within such regions. For dynamic content, the rapidly changing visual content within these regions create difficulties for the encoder 200 to find suitable reference blocks or CTUs within the same frame, potentially leading to increased computational overhead without significant gains in compression efficiency. Additionally, dynamic regions including complex textures may include unique and non-repetitive patterns that may not be efficiently predicted using IBC.

Some video data, such as gaming content, may include a combination of static and dynamic regions within the same frame. Static regions, such as graphical user interfaces (GUI), scoreboards, or other overlay elements, often exhibit significant spatial redundancies and are well-suited for IBC. Conversely, dynamic regions, such as areas depicting gameplay with high motion or complex textures, may lack these redundancies. Selectively applying IBC to static regions while excluding dynamic regions can provide technical benefits by focusing computational resources on areas where IBC is most effective. This targeted approach reduces unnecessary processing in regions where IBC would yield minimal compression gains, optimizing overall efficiency and improving compression performance for mixed-content video data.

In IBC, a mask may define the regions of the video frame containing blocks or CTUs that can be added to the IBC reference buffer. Thus, the mask may determine which parts of the frame are eligible for IBC operations, and the IBC reference buffer may include only those blocks or CTUs specified by the mask. Restricting the parts of the video frame that are eligible for IBC operations by limiting the IBC reference buffer size may add the technical benefit of allowing IBC to be implemented at a local hardware level, where the local hardware may have memory restrictions. In various implementations, the encoder 200 and/or decoder 300 uses a default mask, an extended mask, or both to define the IBC reference buffer. A default mask may serve as a general-purpose configuration, providing a standard definition of regions suitable for IBC. Default masks may be optimized for a variety of scenarios, ensuring broad applicability across diverse video content. However, default masks may also include regions less suited to IBC. To address this, an extended mask can be used to refine, supplement, or replace the default mask, focusing IBC operations on areas where it is most effective (such as areas of the video frame most likely to contain static but not dynamic content).

In various implementations, the mask may be implemented as a list (such as, for example, a binary array or a lookup table), where each entry of the list corresponds to a block or CTU in the video frame. Each entry may indicate the eligibility of each block or CTU for inclusion in the IBC reference buffer. In some examples, each entry of the list may be coded with a 0 value to indicate that the corresponding block or CTU may not be included in the IBC reference buffer and a 1 value to indicate that the corresponding block or CTU may be included in the IBC reference buffer. In various implementations, each entry of the list may be coded with a 1 value to indicate that the corresponding block or CTU may not be included in the IBC reference buffer and a 0 value to indicate that the corresponding block or CTU may be included in the IBC reference buffer.

For example, the mask can be defined as a binary list with the size of the video frame, in blocks or CTUs, rounded up. For a frame size of 1,920×1,080 pixels with blocks or CTUs sized 128×128 pixels, the frame would contain 135 blocks CTUs arranged in a 15×9 grid. Each position in the list corresponds to a block or CTU, with a flag, such as canCTUbufferIBC, set to 0 or 1 to indicate whether the block CTU is eligible for inclusion in the IBC reference buffer.

In various implementations, the mask is represented as a vector, where each element of the vector corresponds to a specific block or CTU in the video frame (for example, in a linearized order of the video frame). As previously described, each element of the vector may be coded with a binary value, such as 0 or 1, to indicate the eligibility of the corresponding block or CTU for inclusion in the IBC reference buffer. For the previously described example video frame, the vector would contain 135 elements, each representing a corresponding block or CTU's eligibility for inclusion in the IBC reference buffer. The vector format may offer technical benefits when processing requires sequential or indexed access to block or CTU information, offering compactness and efficient memory usage while simplifying operations involving multiple blocks or CTUs.

In some examples, the mask is represented as a matrix, where the rows and columns of the matrix correspond to the spatial arrangement of blocks or CTUs in the video frame. Thus, each matrix element may correspond to a specific block or CTU based on its spatial position within the video frame, and may be coded (for example, as previously described) with a binary value, such as 0 or 1, to specify the eligibility of the corresponding block or CTU for inclusion in the IBC reference buffer. For the previously described example video frame, the mask would be a 15×9 matrix, directly mapping block or CTU eligibility for inclusion in the IBC reference buffer to their spatial positions. The matrix representation may offer technical benefits when performing spatially dependent operations, such as limiting eligibility to certain rows or columns or processing adjacent blocks or CTUs together. The matrix structure may also simplify the identification and updating of eligibility for spatially contiguous blocks or CTUs while maintaining an intuitive spatial relationship.

In various implementations, default masks are determined with respect to a selected block or CTU (e.g., the block or CTU being encoded or decoded using IBC). For example, a default mask may include a number of lines above the selected block or CTU, a number of lines below the selected block or CTU, a number of lines to the left of the selected block or CTU, a number of lines to the right of the selected block or CTU, or any combination thereof. In various implementations, number of lines is two.

In some examples, the default mask may be determined with respect to a selected block as well as the location of the selected block within the corresponding CTU. For example, in response to the selected block being within the top-left area (such as, for example, a 64×64 area) of a CTU, the selected block can refer to an area of the left CTU (e.g., the CTU to the left of the CTU containing the selected block). For example, the default mask may include blocks in a bottom-left area (such as, for example, a 64×64 area) of the left CTU as well as blocks in a top-right area (such as, for example, a 64×64 area) of the left CTU.

In various implementations, in response to the selected block being within a top-right area (such as, for example, a 64×64 area) of a CTU and the area at a luma location at the top-left corner of the CTU containing the selected block (such as, for example, (0,64)) has not yet been reconstructed, the default mask includes blocks in the bottom-left area (such as, for example, a 64×64 area) and the bottom right area (such as, for example, a 64×64 area) of the left CTU. Otherwise, the default mask may include blocks in the bottom-right area (such as, for example, a 64×64 area) of the left CTU.

In some examples, in response to the selected block being within a bottom-left area (such as, for example, a 64×64 area) of a CTU and an area at a luma location at the top-left corner of the CTU containing the selected block (such as, for example, (64,0)) has not yet been reconstructed, the default mask includes blocks in the top-right area (such as, for example, a 64×64 area) and the bottom-right area (such as, for example, a 64×64 area) of the left CTU. Otherwise, the default mask may include blocks in the bottom-right area (such as, for example, a 64×64 area) of the left CTU.

In various implementations, in response to the selected block being within the bottom-right area (such as, for example, a 64×64 area) of a CTU, the default mask includes already reconstructed blocks in the CTU containing the selected block. In some examples, the CTU size may be set as a 128×128 block or a 256×256 block.

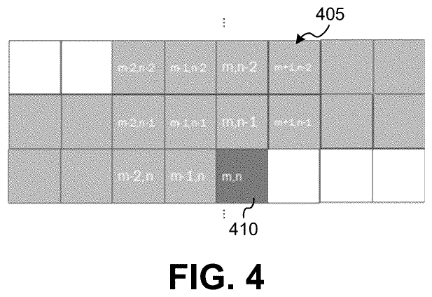

FIG. 4 is a block diagram illustrating a default mask 405 and a selected CTU 410 according to one or more embodiments of the present disclosure. In the implementation of FIG. 4, the selected CTU 410 is located at a position (m, n) within the video frame, where m refers to the column and n refers to the row containing the selected CTU 410. In the example of FIG. 4, the default mask 405 includes CTUs within the video frame in the same row as the selected CTU 410 and to the left of the selected CTU 410, as well as CTUs within two rows above the selected CTU410. Thus, for the selected CTU 410 at the position (m, n), the default mask 405 may include CTUs with indices (m−2, n−2) through (W, n−2), CTUs with indices (0, n−1) through (W, n−1), and CTUs with indices (0, n) through (m, n), where W indicates the maximum horizontal index within the video frame (or tile, slice, picture, etc.). In the example of FIG. 4, the per-sample block search vector range (or local search range) is limited by the default mask 405 to [−(C<<1), C>>2] horizontally and [−C, C>>2] vertically, where C represents the size of the CTU.

In various implementations, extended masks may be defined to include areas of the video frame likely to benefit from IBC operations. For example, as previously described, extended masks may be defined to include areas of the video frame likely to include static content. In the example of mixed-content video frames (e.g., video frames containing gaming content), the extended masks may be defined to include area of the video frame likely to include static content and exclude areas of the video frame likely to include dynamic content. In various implementations, the extended mask includes one or more boundary regions of the video frame. For example, the extended mask may include a top edge region, a left edge region, a bottom edge region, a right edge region, or a combination thereof. Each boundary region may include a number of lines (such as, for example two) of blocks or CTUs extending inwards from a respective edge of the video frame. In various implementations, the extended mask includes an upper-left boundary region, an upper-right boundary region, a lower-left boundary region, a lower-right boundary region, or a combination thereof. Each boundary region may include a number of blocks or CTUs (such as, for example, a 2×2 region of blocks or CTUs) at a respective corner of the video frame.

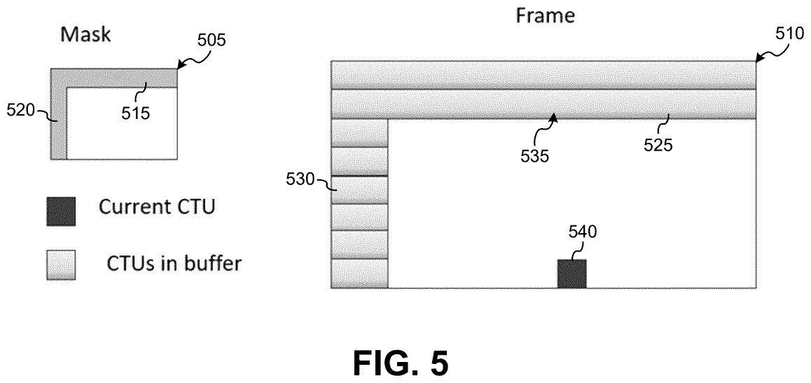

FIG. 5 is a block diagram illustrating a first example of an extended mask 505 and an associated IBC reference buffer 510 according to one or more embodiments of the present disclosure. As shown in FIG. 5, the extended mask 505 includes a top edge region 515 and a left edge region 520 of the video frame. The top edge region 515 may include the uppermost two blocks or CTU rows, and the left edge region 520 may include the leftmost two blocks or CTU columns. When applied to the video frame, the corresponding IBC reference buffer 510 includes these edge regions, facilitating IBC operations within the top edge region 525 and the left edge region 530 as defined by the extended mask 505. In the example of FIG. 5, the maximum size of the IBC reference buffer 510 is sufficient to allow each of the blocks or CTUs included by the extended mask 505 to be loaded into the IBC reference buffer 510. Thus, all the blocks or CTUs included by the extended masks 505 are loaded into the IBC reference buffer 510 as loaded blocks 535, which the encoder 200 and/or decoder 300 may access when performing IBC operations (e.g., encoding or decoding the selected block 540).

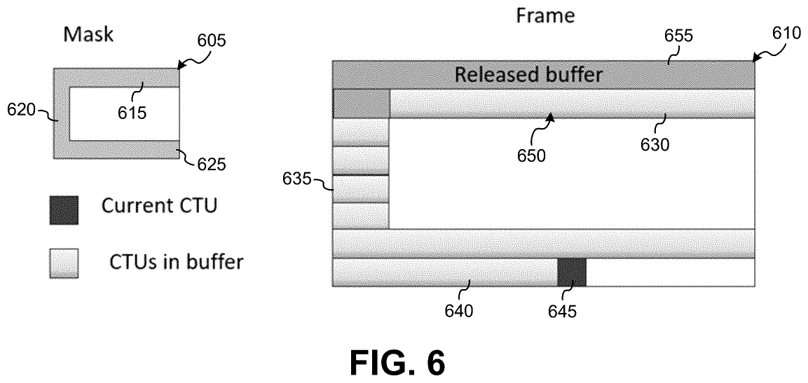

FIG. 6 is a block diagram illustrating a second example of an extended mask 605 and an associated IBC reference buffer 610 according to one or more embodiments of the present disclosure. As shown in FIG. 6, the extended mask 605 includes a top edge region 615, a left edge region 620, and a bottom edge region 625 of the video frame. The top edge region 615 may include the uppermost two blocks or CTU rows, the left edge region 620 may include the leftmost two blocks or CTU columns, and the bottom edge region 625 may include the lowermost two blocks or CTU rows. When applied to the video frame, the corresponding IBC reference buffer 610 includes these edge regions, facilitating IBC operations within the top edge region 630, the left edge region 635, and the bottom edge region 640 as defined by the extended mask 605.

In the example of FIG. 6, the maximum size of the IBC reference buffer 610 is insufficient to allow all the blocks or CTUs included by the extended mask 605 to be loaded into the IBC reference buffer 610 simultaneously. Therefore, some blocks or CTUs included by the extended mask 605 may be released from the IBC reference buffer 610 as released blocks 655. The remaining blocks or CTUs may be loaded into the IBC reference buffer 610 as loaded blocks 650, which the encoder 200 and/or decoder 300 may access when performing IBC operations (e.g., encoding or decoding the selected block 645). In various implementations, blocks are released from the IBC reference buffer 610 in a specific order to keep certain overlay regions in the IBC reference buffer for as long as possible. In some examples, each block or CTU is assigned a release priority order in the IBC reference buffer 610.

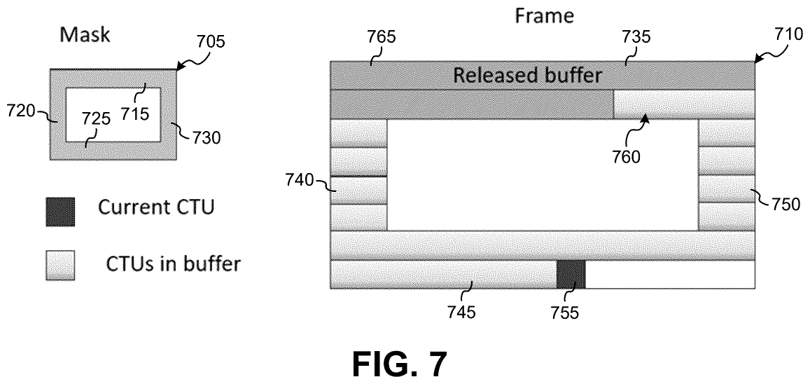

FIG. 7 is a block diagram illustrating a third example of an extended mask 705 and an associated IBC reference buffer 710 according to one or more embodiments of the present disclosure. As shown in FIG. 7, the extended mask 705 includes a top edge region 715, a left edge region 720, a bottom edge region 725, and a right edge region 730 of the video frame. The top edge region 715 may include the uppermost two blocks or CTU rows, the left edge region 720 may include the leftmost two blocks or CTU columns, the bottom edge region 725 may include the lowermost two blocks or CTU rows, and the right edge region 730 may include the rightmost two blocks or CTU columns. When applied to the video frame, the corresponding IBC reference buffer 710 includes these edge regions, facilitating IBC operations within the top edge region 735, the left edge region 740, the bottom edge region 745, and the right edge region 750 as defined by the extended mask 705.

In the example of FIG. 7, the maximum size of the IBC reference buffer 710 is insufficient to accommodate all the blocks or CTUs included by the extended mask 705 at once. Consequently, some blocks or CTUs included by the extended mask 705 may be released from the IBC reference buffer 710 as released blocks 765. The blocks or CTUs that remain are loaded into the IBC reference buffer 710 as loaded blocks 760, which the encoder 200 and/or decoder 300 may access when performing IBC operations (e.g., encoding or decoding the selected block 755). In various implementations, blocks are released from the IBC reference buffer 710 in a specific order to keep certain overlay regions in the IBC reference buffer for as long as possible. In some examples, each block or CTU is assigned a release priority order in the IBC reference buffer 710.

While FIGS. 5-7 illustrate specific examples of extended masks and associated IBC reference buffers, it should be understood that these are non-limiting examples, and other configurations are possible. The extended masks can include any combination of edges, corners, or other portions of the video frame (e.g., non-boundary regions with static image data), with various dimensions tailored to specific needs. For example, in addition to predefined masks, extended masks may include user defined masks. In various implementations, the maximum size of the IBC reference buffer may be defined by the size of a user defined mask. In some examples, the extended masks (including any predefined masks and/or any user defined masks) are stored in a library. The library may be pre-loaded into the encoder 200 and/or the decoder. In various implementations, the library may be stored on non-transitory computer-readable storage media, such as at the memory 120. In some examples, the library may be stored on non-transitory computer-readable storage media at a computing platform remote from the system 100, and the system 100 may access the library via the communication channel 190.

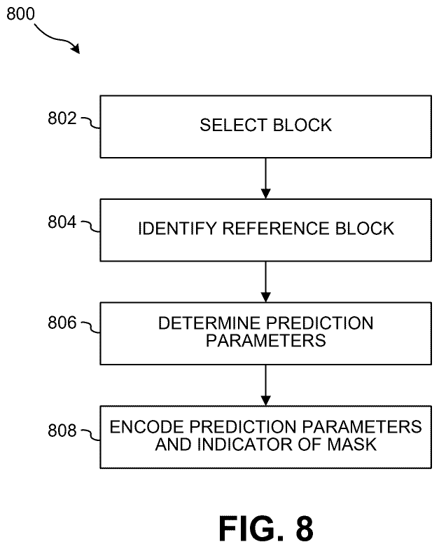

FIG. 8 is a flowchart illustrating an example process 800 for encoding a video frame according to one or more embodiments of the present disclosure. Although the operations of the process 800 are illustrated with reference to particular examples disclosed herein (e.g., components of the system 100, such as, for example, the video encoder 200 and the video decoder 300), the process 800 may be used in any suitable setting. Operations are illustrated once each and in a particular order in FIG. 8, but in other examples, the operations may be reordered and/or repeated as desired or appropriate (e.g., different operations may be performed in parallel, as may be suitable).

In the example process 800, the encoder 200 selects a block or CTU from a video frame for encoding (at block 802). For example, the encoder 200 loads a mask, such as a default mask, an extended mask, or a combination of a default mask and an extended mask. In various implementations, the encoder 200 selects the block or CTU from within the region of the loaded mask for which IBC operations are valid. In some examples, the encoder 200 selects the block or CTU from anywhere within the video frame.

In the example process 800, the encoder 200 identifies a reference block or CTU (at block 804). For example, the encoder 200 initializes an IBC reference buffer based on the loaded mask by adding blocks or CTUs within the video frame within the regions of the loaded mask for which IBC operations are valid. The encoder 200 may search the blocks or CTUs in the IBC reference buffer to identify a block or CTU having a highest similarity to the selected block or CTU as a reference block or CTU. In various implementations, the encoder 200 computes similarity metrics between the selected block or CTU and potential reference blocks or CTUs within the IBC reference buffer. The potential reference block or CTU having the highest similarity with the selected block or CTU (as indicated by the similarity metrics) may be identified as the reference block. Examples of suitable similarity metrics include a sum of absolute differences (SAD), a sum of squared differences (SSD), a mean absolute difference (MAD), a mean square error (MSE), a normalized cross-correlation (NCC), a structural similarity index (SSIM), a bitrate-cost-weighted metric, hybrid metrics (e.g., a combination of the aforementioned metrics), etc.

In the example process 800, the encoder 200 determines prediction parameters based on a relationship between the selected block or CTU and the identified reference block or CTU (at block 806). In various implementations, the prediction parameters include a displacement parameter capturing the spatial relationship between the selected block or CTU and the reference block or CTU. In some examples, the displacement parameter is represented as a block vector (BV). A block vector may be a data structure that specifies the spatial displacement between the selected block or CTU and the reference block or CTU. The block vector may be defined with respect to both luma and chroma components of the video data. Thus, in various implementations, the block vector includes a luma block vector component and a chroma block vector component. The luma block vector component may represent displacement information specific to the luminance (Y) channel, while the chroma block vector component may represent displacement information for the chrominance (U and V) channels. In some examples, the luma block vector component and/or the chroma block vector component may be computed with integer precision (e.g., displacement values may be represented as whole numbers or integers). In various implementations, the prediction parameters include a residual parameter capturing the residual or residual data. The residual parameter may represent differences between the contents of the selected block or CTU and the contents of the reference block or CTU.

In various implementations, the encoder 200 may implement IBC in an adaptive motion vector resolution (AMVR) mode. In the AMVR mode, the block vector can switch between 1-pel and 4-pel motion vector precisions. In some examples, the encoder 200 may implement IBC in an IBC skip/merge mode. In the IBC skip/merge mode, a merge candidate index specifies which block vector from a candidate list—derived from neighboring IBC-coded blocks—is used to predict the current block. The merge candidate list may include spatial candidates, history-based motion vector predictors (HMVP), pairwise candidates, etc.

In various implementations, the encoder 200 may implement IBC in an advanced motion vector prediction (AMVP) mode. In the AMVP mode, the block vector difference may be coded similarly to a motion vector difference. The block vector prediction method selects two predictors from the merge candidate list based on minimum cost (when IBC coding is applied). When either neighboring predictor is unavailable, a default block vector may serve as the predictor. A flag may be signaled to indicate the chosen block vector predictor index. In some examples, the IBC mode used may be signaled with a flag at the CU level.

In the example process 800, the prediction parameters and an indicator of the fixed mask and/or IBC reference buffer used is encoded into the bitstream (at block 808). In various implementations, the indicator may include an indication of whether an extended mask or IBC reference buffer is used to encode the current video frame. For example, a useIBCBufferMask flag may be signaled in a picture parameter set (PPS) of the bitstream to indicate whether an extended mask or IBC reference buffer is used to encode the current video frame. In various implementations, the PPS is encoded into the bitstream ahead of the encoding data for the current video frame. When the indicator indicates that an extended mask or IBC reference buffer is not used (e.g., useIBCBufferMask=0), the indicator may signal to the decoder 300 that the default mask was used to define the IBC reference buffer.

When the indicator indicates that an extended mask or IBC reference buffer is used to encode the current video frame (e.g., useIBCBufferMask=1), an additional indicator may be included to indicate whether the extended mask is a predefined mask or a custom user-defined mask. For example, an additional is isIBCBufferMaskLUT flag may be encoded into the PPS of the bitstream. When the additional indicator indicates that a predefined mask is used (e.g., isIBCBufferMaskLUT=1), the indicator may additionally include an indicator pointing to the predefined extended mask from the library that was used to encode the video frame. As previously described, the library may be pre-loaded at the encoder 200 and/or decoder 300, or stored at a different location.

When the indicator indicates that a custom user-defined extended mask is used (e.g., isIBCBufferMaskLUT=0), two additional indicators may be encoded into the bitstream (e.g., at the sequence parameter set [SPS] at the beginning of the bitstream). For example, a useIBCCustomBuffer flag may be encoded into the SPS to indicate whether a custom user-defined mask is used. Additionally, an IBCCustomBufferLUT lookup table may be encoded into the SPS to define the shape of the custom user-defined mask. A customIBCBufferMaskLUTsize indicator of the size of the custom user-defined mask may be encoded into the SPS. In various implementations, when the encoder 200 or decoder 300 determines that the indicator indicates that a custom user-defined extended mask is used (e.g., isIBCBufferMaskLUT=0) but either the customIBCBufferMaskLUTsize or the customIBCBufferMaskLUT indicators are unavailable, the encoder 200 or decoder 300 may set the useIBCBufferMask flag to 0.

Tables 1 and 2 below show examples of the previously described syntax elements.

TABLE 1

| | Descriptor |
|---|---|
| sps_parameter_set_rbsp( ) { | |
| ... | |
| sps_use_custom_ibc_buffer | u(1) |
| if( sps_use_custom_ibc_buffer ) { | |
| sps_custom_ibc_buffer_lut | ae(v) |
| } | |

TABLE 2

| | Descriptor |
|---|---|
| pic_parameter_set_rbsp( ) { | |
| ... | |
| pps_use_ibc_buffer_mask | u(1) |
| if( pps_use_ibc_buffer_mask ) { | |
| pps_is_ibc_buffer_mask_lut | u(1) |
| if( pps_is_ibc_buffer_mask_lut ) { | |
| pps_use_new_ibc_buffer_mask | u(1) |
| if( pps_use_new_ibc_buffer_mask) { | |
| pps_ibc_buffer_mask_lut_idx | ue(v) |
| } | |
| } | |
| if( !pps_is_ibc_buffer_mask_lut && | |
| sps_use_ibc_custom_buffer) { | |
| pps_ibc_custom_buffer_lut_idx | ue(v) |
| } | |
| } | |

In various implementations, the useIBCBufferMask flag may be signaled at a sequence level in the SPS. In some examples, an SPS flag useIBCBufferMaskTiD may be used to indicate a maximum temporal ID (TiD) where a mask or IBC reference buffer can be used. In various implementations, the mask or IBC reference buffer may only be used for high quality frames (such as, for example, frames with a low TiD). For example, when useIBCBufferMaskTiD=2, the mask or IBC reference buffer is used only for frames having a TiD of less than 2.

In various implementations, the indicator includes a list, vector, or matrix defining the shape of the extended mask. In some examples, the indicator includes the library. In various implementations, the indicator does not include information defining the shape of the extended mask, but rather includes information identifying the extended mask in the library. For example, the library may include a lookup table including a plurality of masks, where each mask is associated with a single unique index value from a plurality of index values. The indicator may include the unique index value associated with the relevant mask. In some examples, the indicator may be encoded into the bitstream using a lossless compression technique, such as entropy encoding.

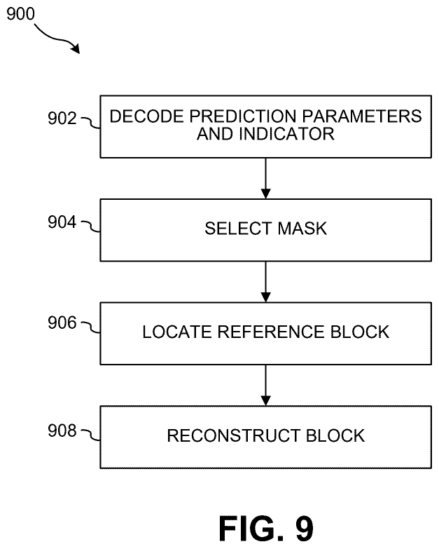

FIG. 9 is a flowchart illustrating an example process 900 for decoding a video according to one or more embodiments of the present disclosure. Although the operations of the process 900 are illustrated with reference to particular examples disclosed herein (e.g., components of the system 100, such as, for example, the video encoder 200 and the video decoder 300), the process 900 may be used in any suitable setting. Operations are illustrated once each and in a particular order in FIG. 9 but in other examples, the operations may be reordered and/or repeated as desired or appropriate (e.g., different operations may be performed in parallel, as may be suitable).

In the example process 900, the decoder 300 decodes prediction parameters and an indicator from a bitstream (at block 902). The prediction parameters and the indicator may be any of the prediction parameters and indicators previously described as being encoded into the bitstream by the encoder 200. In examples where the indicator is encoded into the bitstream using a lossless compression technique such as entropy encoding, the indicator is decoded using the corresponding decompression or decoding technique.

In the example process 900, the decoder 300 selects a mask based on the indicator decoded from the bitstream (at block 904). For example, when the indicator indicates that a default mask is used (e.g., when the flag useIBCBufferMask=0), the decoder 300 selects the default mask. When the indicator specifies that an extended mask is used (e.g., when the flag useIBCBufferMask=1), the decoder 300 selects the corresponding extended mask. For example, the decoder 300 may retrieve the extended mask from the library. As previously described, the library may be pre-loaded at the decoder 300. In various implementations, the library is stored at the storage device 140 or at a remote platform accessible via the communication channel 190. In some examples, the library is encoded into the bitstream, and the decoder 300 reconstructs the library. In various implementations, the decoder 300 reconstructs the extended mask based on the shape of the mask encoded into the bitstream.

The decoder 300 may then select a block or CTU of the video frame for reconstruction. The decoder 300 may initialize the IBC reference buffer based on the shape of the mask and/or the location of the selected block or CTU for reconstruction, as may be appropriate. In the example process 900, the decoder 300 locates a reference block or CTU (at block 906). In various implementations, the decoder 300 locate the reference block or CTU based on the displacement parameter component of the prediction parameters decoded from the bitstream. In some examples, the decoder 300 may only be able to access the IBC reference buffer to locate the reference block or CTU. This ensures that the same regions of the video frame are used for encoding and decoding, ensuring consistency between the IBC operations of the encoder 200 and the decoder 300.

In the example process 900, the decoder 300 reconstructs the selected block (at block 908). In various implementations, the decoder 300 reconstructs the selected block based on the residual parameter component of the prediction parameters decoded from the bitstream.

The following paragraphs provide examples of systems, methods, and devices implemented in accordance with this specification.
Example 1. A computer-implemented method for encoding a video frame, comprising: selecting a block from a plurality of blocks within the video frame; identifying a reference block within a reference boundary region of the video frame, the reference boundary region being defined by a fixed mask, and the reference boundary region being less than all of the video frame; determining prediction parameters based on a relationship between the selected block and the identified reference block; and encoding, with an encoder, the prediction parameters and an indicator of the fixed mask into a bitstream.
Example 2. The computer-implemented method of example 1, wherein the indicator identifies a predefined fixed mask in a library.
Example 3. The computer-implemented method of example 2, wherein the library includes a plurality of predefined fixed masks defining different reference boundary regions within the video frame.
Example 4. The computer-implemented method of example 3, wherein the library includes a lookup table.
Example 5. The computer-implemented method of any one of examples 3 or 4, wherein each predefined fixed mask of the plurality of predefined fixed masks is associated with a single index value from a plurality of index values, wherein the indicator of the fixed mask includes one index value from the plurality of index values, the one index value being associated with the fixed mask.
Example 6. The computer-implemented method of any one of examples 2-5, wherein the library is encoded into the bitstream.
Example 7. The computer-implemented method of example 6, wherein the library is encoded into a sequence parameter set at a beginning of the bitstream.
Example 8. The computer-implemented method of any one of examples 2-5, wherein the library is pre-loaded into the encoder.
Example 9. The computer-implemented method of any one of examples 2-5, wherein the library is stored on a non-transitory computer-readable storage medium at a location remote from the encoder.
Example 10. The computer-implemented method of any one of examples 1-9, wherein the indicator of the fixed mask defines the reference boundary region.
Example 11. The computer-implemented method of any one of examples 1-10, wherein the reference boundary region includes at least one of a top edge region, a left edge region, a bottom edge region, and a right edge region.
Example 12. The computer-implemented method of any one of examples 1-10, wherein the reference boundary region includes a top edge region and at least one of a left edge region, a bottom edge region, and a right edge region of the video frame.
Example 13. The computer-implemented method of any one of examples 1-10, wherein the reference boundary region includes at least one of an upper-left region, an upper-right region, a lower-left region, and a lower-right region.
Example 14. A computer-implemented method for decoding a video frame, comprising: decoding, with a decoder, prediction parameters and an indicator of a fixed mask from a bitstream; selecting the fixed mask based on the indicator; locating a reference block within a reference boundary region of the video frame, the reference boundary region being defined by the fixed mask, and the reference boundary region being less than all of the video frame; and reconstructing a first block of the video frame based on the reference block and the prediction parameters.
Example 15. The computer-implemented method of example 14, wherein the indicator identifies a predefined fixed mask in a library.
Example 16. The computer-implemented method of example 15, wherein the library includes a plurality of predefined fixed masks defining different reference boundary regions within the video frame.
Example 17. The computer-implemented method of example 16, wherein the library includes a lookup table.
Example 18. The computer-implemented method of any one of examples 16 or 17, wherein each predefined fixed mask of the plurality of predefined fixed masks is associated with a single index value from a plurality of index values, wherein the indicator of the fixed mask includes one index value from the plurality of index values, the one index value being associated with the fixed mask.
Example 19. The computer-implemented method of any one of examples 15-18, wherein the library is encoded into the bitstream.
Example 20. The computer-implemented method of example 19, wherein the library is encoded into a sequence parameter set at a beginning of the bitstream.
Example 21. The computer-implemented method of any one of examples 15-18, wherein the library is pre-loaded into the decoder.
Example 22. The computer-implemented method of any one of examples 15-18, wherein the library is stored on a non-transitory computer-readable storage medium at a location remote from the decoder.
Example 23. The computer-implemented method of any one of examples 14-22, wherein the indicator of the fixed mask defines the reference boundary region.
Example 24. The computer-implemented method of any one of example 14-23, wherein the reference boundary region includes at least one of a top edge region, a left edge region, a bottom edge region, and a right edge region.
Example 25. The computer-implemented method of any one of examples 14-23, wherein the reference boundary region includes a top edge region and at least one of a left edge region, a bottom edge region, and a right edge region of the video frame.
Example 26. The computer-implemented method of any one of examples 14-23, wherein the reference boundary region includes at least one of an upper-left region, an upper-right region, a lower-left region, and a lower-right region.
Example 27. A non-transitory computer-readable storage medium comprising instructions that, when executed by an electronic processor, cause the electronic processor to perform a set of operations comprising: selecting a block from a plurality of blocks within a video frame; identifying a reference block within a reference boundary region of the video frame, the reference boundary region being defined by a fixed mask, and the reference boundary region being less than all of the video frame; determining prediction parameters based on a relationship between the selected block and the identified reference block; and encoding, with an encoder, the prediction parameters and an indicator of the fixed mask into a bitstream.
Example 28. The non-transitory computer-readable storage medium of example 27, wherein the indicator identifies a predefined fixed mask in a library.
Example 29. The non-transitory computer-readable storage medium of example 28, wherein the library includes a plurality of predefined fixed masks defining different reference boundary regions within the video frame.
Example 30. The non-transitory computer-readable storage medium of example 29, wherein the library includes a lookup table.
Example 31. The non-transitory computer-readable storage medium of any one of examples 29 or 30, wherein each predefined fixed mask of the plurality of predefined fixed masks is associated with a single index value from a plurality of index values, wherein the indicator of the fixed mask includes one index value from the plurality of index values, the one index value being associated with the fixed mask.
Example 32. The non-transitory computer-readable storage medium of any one of examples 28-31, wherein the library is encoded into the bitstream.
Example 33. The non-transitory computer-readable storage medium of example 32, wherein the library is encoded into a sequence parameter set at a beginning of the bitstream.
Example 34. The non-transitory computer-readable storage medium of any one of examples 28-31, wherein the library is pre-loaded into the encoder.
Example 35. The non-transitory computer-readable storage medium of any one of examples 28-31, wherein the library is stored on a non-transitory computer-readable storage medium at a location remote from the encoder.
Example 36. The non-transitory computer-readable storage medium of any one of examples 27-35, wherein the indicator of the fixed mask defines the reference boundary region.
Example 37. The non-transitory computer-readable storage medium of any one of examples 27-36, wherein the reference boundary region includes at least one of a top edge region, a left edge region, a bottom edge region, and a right edge region.
Example 38. The non-transitory computer-readable storage medium of any one of examples 27-36, wherein the reference boundary region includes a top edge region and at least one of a left edge region, a bottom edge region, and a right edge region of the video frame.
Example 39. The non-transitory computer-readable storage medium of any one of examples 27-36, wherein the reference boundary region includes at least one of an upper-left region, an upper-right region, a lower-left region, and a lower-right region.
Example 40. A non-transitory computer-readable storage medium comprising instructions that, when executed by an electronic processor, cause the electronic processor to perform a set of operations comprising: decoding, with a decoder, prediction parameters and an indicator of a fixed mask from a bitstream; selecting the fixed mask based on the indicator; locating a reference block within a reference boundary region of a video frame, the reference boundary region being defined by the fixed mask, and the reference boundary region being less than all of the video frame; and reconstructing a first block of the video frame based on the reference block and the prediction parameters.
Example 41. The non-transitory computer-readable storage medium of example 40, wherein the indicator identifies a predefined fixed mask in a library.
Example 42. The non-transitory computer-readable storage medium of example 41, wherein the library includes a plurality of predefined fixed masks defining different reference boundary regions within the video frame.
Example 43. The non-transitory computer-readable storage medium of example 42, wherein the library includes a lookup table.
Example 44. The non-transitory computer-readable storage medium of any one of examples 42 or 43, wherein each predefined fixed mask of the plurality of predefined fixed masks is associated with a single index value from a plurality of index values, wherein the indicator of the fixed mask includes one index value from the plurality of index values, the one index value being associated with the fixed mask.
Example 45. The non-transitory computer-readable storage medium of any one of examples 41-44, wherein the library is encoded into the bitstream.
Example 46. The non-transitory computer-readable storage medium of example 45, wherein the library is encoded into a sequence parameter set at a beginning of the bitstream.
Example 47. The non-transitory computer-readable storage medium of any one of examples 41-44, wherein the library is pre-loaded into the decoder.
Example 48. The non-transitory computer-readable storage medium of any one of examples 41-44, wherein the library is stored on a non-transitory computer-readable storage medium at a location remote from the decoder.
Example 49. The non-transitory computer-readable storage medium of any one of examples 40-48, wherein the indicator of the fixed mask defines the reference boundary region.
Example 50. The non-transitory computer-readable storage medium of any one of examples 40-49, wherein the reference boundary region includes at least one of a top edge region, a left edge region, a bottom edge region, and a right edge region.
Example 51. The non-transitory computer-readable storage medium of any one of examples 40-49, wherein the reference boundary region includes a top edge region and at least one of a left edge region, a bottom edge region, and a right edge region of the video frame.
Example 52. The non-transitory computer-readable storage medium of any one of examples 40-49, wherein the reference boundary region includes at least one of an upper-left region, an upper-right region, a lower-left region, and a lower-right region.
Example 53. A device, comprising: a encoder configured to: select a block from a plurality of blocks within a video frame, identify a reference block within a reference boundary region of the video frame, the reference boundary region being defined by a fixed mask, and the reference boundary region being less than all of the video frame, determine prediction parameters based on a relationship between the selected block and the identified reference block, and encode the prediction parameters and an indicator of the fixed mask into a bitstream.
Example 54. The device of example 53, wherein the indicator identifies a predefined fixed mask in a library.
Example 55. The device of example 54, wherein the library includes a plurality of predefined fixed masks defining different reference boundary regions within the video frame.
Example 56. The device of example 55, wherein the library includes a lookup table.
Example 57. The device of any one of examples 55 or 56, wherein each predefined fixed mask of the plurality of predefined fixed masks is associated with a single index value from a plurality of index values, wherein the indicator of the fixed mask includes one index value from the plurality of index values, the one index value being associated with the fixed mask.
Example 58. The device of any one of examples 54-57, wherein the library is encoded into the bitstream.
Example 59. The device of example 58, wherein the library is encoded into a sequence parameter set at a beginning of the bitstream.
Example 60. The device of any one of examples 54-57, wherein the library is pre-loaded into the encoder.
Example 61. The device of any one of examples 54-57, wherein the library is stored on a non-transitory computer-readable storage medium at a location remote from the encoder.
Example 62. The device of any one of examples 53-61, wherein the indicator of the fixed mask defines the reference boundary region.
Example 63. The device of any one of examples 53-62, wherein the reference boundary region includes at least one of a top edge region, a left edge region, a bottom edge region, and a right edge region.
Example 64. The device of any one of examples 53-62, wherein the reference boundary region includes a top edge region and at least one of a left edge region, a bottom edge region, and a right edge region of the video frame.
Example 65. The device of any one of example 53-62, wherein the reference boundary region includes at least one of an upper-left region, an upper-right region, a lower-left region, and a lower-right region.
Example 66. A device, comprising: a decoder configured to: decode prediction parameters and an indicator of a fixed mask from a bitstream, select the fixed mask based on the indicator, locate a reference block within a reference boundary region of a video frame, the reference boundary region being defined by the fixed mask, and the reference boundary region being less than all of the video frame, and reconstruct a first block of a video frame based on the reference block and the prediction parameters.
Example 67. The device of example 66, wherein the indicator identifies a predefined fixed mask in a library.
Example 68. The device of example 67, wherein the library includes a plurality of predefined fixed masks defining different reference boundary regions within the video frame.
Example 69. The device of example 68, wherein the library includes a lookup table.
Example 70. The device of any one of examples 68 or 69, wherein each predefined fixed mask of the plurality of predefined fixed masks is associated with a single index value from a plurality of index values, wherein the indicator of the fixed mask includes one index value from the plurality of index values, the one index value being associated with the fixed mask.
Example 71. The device of any one of examples 67-70, wherein the library is encoded into the bitstream.
Example 72. The device of example 71, wherein the library is encoded into a sequence parameter set at a beginning of the bitstream.
Example 73. The device of any one of example 67-70, wherein the library is pre-loaded into the decoder.
Example 74. The device of any one of examples 67-70, wherein the library is stored on a non-transitory computer-readable storage medium at a location remote from the decoder.
Example 75. The device of any one of examples 66-74, wherein the indicator of the fixed mask defines the reference boundary region.
Example 76. The device of any one of examples 66-75, wherein the reference boundary region includes at least one of a top edge region, a left edge region, a bottom edge region, and a right edge region.
Example 77. The device of any one of examples 66-75, wherein the reference boundary region includes a top edge region and at least one of a left edge region, a bottom edge region, and a right edge region of the video frame.
Example 78. The device of any one of examples 66-75, wherein the reference boundary region includes at least one of an upper-left region, an upper-right region, a lower-left region, and a lower-right region.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various methods and aspects described herein can be used to modify one or more modules. For example, the intra predictors and inter predictors described with respect to FIGS. 2 and 3 may be implemented as one or more modules and modified according to the various embodiments of the present disclosure.

The various embodiments described herein provide at least the following features, devices or aspects, alone or on any combination, across various claim categories and types:
i. Encoding, into coded video data, syntax elements that can enable the decoder to decode the coded video data, according to any of the embodiments described herein.
ii. A bitstream that includes one or more of the described syntax elements, or variations thereof, whether transmitted, stored, or otherwise made available.
iii. Creating, transmitting, receiving, and/or decoding of the bitstream.
iv. An electronic device (e.g., TV, set-top box, mobile phone, tablet, etc.) that tunes a channel to receive a bitstream or that receives such bitstream over the air. The electronic device decodes the syntax elements from the bitstream, and, optionally, displays (e.g., via a monitor or other type of display) a resulting image.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

“Decoding,” as used herein, encompasses all or part of the processes performed, for example, on an encoded sequence to produce an output suitable for display. In some embodiments, such processes include one or more of the processes typically performed by a decoder, for example, entropy decoding, inverse quantization, etc. Whether the phrase “decoding process” is intended to refer to a subset of operations or generally to the broader decoding process will be clear based on the context of the specific description and will be well understood by those skilled in the art.

“Encoding,” as used herein, encompasses all or part of the processes performed, for example, on input video data an order to produce an encoded bitstream. Additionally, the terms “reconstructed” and “decoded” may be used interchangeably, the terms “encoded” or “coded” may be used interchangeably, the terms “image,” “picture,” “sub-picture,” “slice,” and “frame” may be used interchangeably, and the terms “pixel” and “sample” may be used interchangeably.

The present disclosure refers to information, for example, syntax elements, that can be transmitted or stored. Such information can be packaged or arranged in a variety of manners, including for example manners common in video standards such as putting the information into a sequence parameter set (SPS), a picture parameter set (PPS), a network abstraction layer (NAL) unit, a header (for example, a NAL unit header, or a slice header), or an SEI message. Other manners are also available, including, for example, manners that are common for system level or application-level standards such as signaling the information into one or more of the following:
i. session description protocol (SDP), for example as described in RFCs and/or used in conjunction with real-time transport protocol (RTP) transmission.
ii. hypertext transfer protocol (HTTP) live Streaming (HLS) manifest transmitted over HTTP.
iii. dynamic adaptive streaming over HTTP (DASH) media presentation description (MPD) descriptors, for example as used in DASH and transmitted over HTTP.
iv. RTP header extensions, for example as used during RTP streaming.
v. International Organization for Standardization (ISO) base media file format, for example, as used in Omnidirectional MediA Format (OMAF).

As used herein, “signal” and “signaling” refer to, among other things, indicating information to a decoder. For example, in some embodiments the encoder signals a quantization matrix for de-quantization, whereby the same parameter is used for both encoding and decoding. In some embodiments, the signaling may be explicit, such that information (e.g., a particular parameter) is transmitted to the decoder enabling the decoder to use the same particular parameter. In some embodiments, the signaling may be implicit, in that the information (e.g., a particular parameter) is indicated based on other information at or transmitted to the decoder or derived or selected by the decoder based on information available at the decoder. By not transmitting the information (e.g., the particular parameter), a bit savings is thus realized in some embodiments. In some embodiments, one or more syntax elements or flags are used to signal information to a decoder. While the preceding relates to the verb form of the word “signal”, the word “signal” can also be used herein as a noun.

In some embodiments, signals may be produced that are formatted to carry information that may be stored or transmitted. Such information may include, for example, instructions for performing a method, or data produced by one of the described implementations (e.g., a bitstream of a described embodiment). Such a signal may be formatted, for example, as an electromagnetic wave or as a baseband signal. The formatting may include, for example, encoding a data stream and modulating a carrier with the encoded data stream. The information that the signal carries may be, for example, analog or digital information. The signal may be transmitted over a variety of different wired or wireless links and may be stored on a processor-readable medium.

It is to be understood that use of any of the following “/”, “and/of”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

1-20. (canceled)

21. A device for video decoding comprising:
a processor configured to:
obtain a picture comprising a plurality of reconstructed blocks associated with a current block;
apply an intra block copy (IBC) reference mask to determine which of the plurality of reconstructed blocks associated with the picture are added to an IBC reference buffer, wherein the IBC reference buffer comprises a subset of the plurality of reconstructed blocks;
select a reconstructed block from the subset of the plurality of reconstructed blocks; and
decode the current block based on the selected reconstructed block.

22. A device for video encoding comprising:
a processor configured to:
obtain a picture comprising a plurality of reconstructed blocks associated with a current block;
apply an intra block copy (IBC) reference mask to determine which of the plurality of reconstructed blocks associated with the picture are added to an IBC reference buffer, wherein the IBC reference buffer comprises a subset of the plurality of reconstructed blocks;
select a reconstructed block from the subset of the plurality of reconstructed blocks; and
encode the current block based on the selected reconstructed block.

23. The device of claim 21, wherein the processor is further configured to receive an indication associated with the IBC reference mask.

24. The device of claim 23, wherein the indication associated with the IBC reference mask is received in a sequence parameter set (SPS) or picture parameter set (PPS).

25. The device of claim 22, wherein the processor is further configured to send an indication associated with the IBC reference mask.

26. The device of claim 25, wherein the indication associated with the IBC reference mask is sent in an SPS or PPS.

27. The device of claim 23, wherein the indication associated with the IBC reference mask references at least one IBC reference mask from a lookup table.

28. The device of claim 27, wherein the indication associated with the IBC reference mask is based on a frame size and a coding tree unit (CTU) size.

29. The device of claim 21, wherein the reconstructed block is selected from at least one of a top row, a second top row, a leftmost column, a second leftmost column, a bottom row, a second bottom row, a rightmost column, or a second rightmost column of the picture.

30. The device of claim 21, wherein the processor is further configured to assign a respective release priority value to each reconstructed block within the IBC reference buffer.

31. A method for video decoding comprising:
obtaining a picture comprising a plurality of reconstructed blocks associated with a current block;
applying an intra block copy (IBC) reference mask to determine which of the plurality of reconstructed blocks associated with the picture are added to an IBC reference buffer, wherein the IBC reference buffer comprises a subset of the plurality of reconstructed blocks;
selecting a reconstructed block from the subset of the plurality of reconstructed blocks; and
decoding the current block based on the selected reconstructed block.

32. A method for video encoding comprising:
obtaining a picture comprising a plurality of reconstructed blocks associated with a current block;
applying an intra block copy (IBC) reference mask to determine which of the plurality of reconstructed blocks associated with the picture are added to an IBC reference buffer, wherein the IBC reference buffer comprises a subset of the plurality of reconstructed blocks;
selecting a reconstructed block from the subset of the plurality of reconstructed blocks; and
encoding the current block based on the selected reconstructed block.

33. The method of claim 31, wherein the method further comprises receiving an indication associated with the IBC reference mask.

34. The method of claim 33, wherein the indication associated with the IBC reference mask is received in a sequence parameter set (SPS) or picture parameter set (PPS).

35. The method of claim 32, wherein the method further comprises sending an indication associated with the IBC reference mask.

36. The method of claim 35, wherein the indication associated with the IBC reference mask is sent in an SPS or PPS.

37. The method of claim 33, wherein the indication associated with the IBC reference mask references at least one IBC reference mask from a lookup table.

38. The method of claim 37, wherein the indication associated with the IBC reference mask is based on a frame size and a coding tree unit (CTU) size.

39. The method of claim 31, wherein the reconstructed block is selected from at least one of a top row, a second top row, a leftmost column, a second leftmost column, a bottom row, a second bottom row, a rightmost column, or a second rightmost column of the picture.

40. The method of claim 31, wherein the method further comprises assigning a respective release priority value to each reconstructed block within the IBC reference buffer.
